(19) United States
(12) Patent Application Publication
(10) Pub. No.: US 2008/0025782 A1
(43) Pub. Date: Jan. 31, 2008

(54) Printer and printer control method

(75) Inventors: Kaoru Koyama, Shiojiri-shi (JP); Hitoshi Igarashi, Shiojiri-shi (JP); Takuya Yasue, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/880,784

(22) Filed: Jul. 24, 2007

(30) Foreign Application Priority Data
Jul. 25, 2006 (JP) 2006-201669

(51) Int. Cl. B41J 11/04

(52) U.S. Cl. 400/582

(57) ABSTRACT

A printer for performing a printing operation on a printing medium, includes: a feed roller, operable to feed the printing medium from a medium setting portion in which the printing medium is set; a feeding motor, operable to drive the feed roller; a transport roller, operable to transport the printing medium fed from the medium setting portion; a transporting motor, operable to drive the transport roller; and a controller, operable to control the transporting motor based on a first speed profile indicating a relationship between a rotation time or a rotation distance and a target peripheral speed of the transport roller, and to control the feeding motor based on a second speed profile indicating a relationship between a rotation time or a rotation distance and a target peripheral speed of the feed roller and being substantially equal to the first speed profile.

### BACKGROUND

1. Technical Field

The present invention relates to a printer and a method of controlling a printer.

2. Related Art

As ink jet printers for performing a printing operation on a predetermined printing medium such as a printing sheet, there are printers having a feed roller that feeds a printing sheet into the printer and a paper transport roller that transports the printing sheet at the time of performing a printing operation on the printing sheet fed into the printer (for example, JP-A-2003-72964 and JP-A-2006-117385).

In the printer described in JP-A-2003-72964, the feed roller is connected to a paper transporting motor rotationally driving the paper transport roller through a clutch and is detachable from the paper transporting motor. In the printer described in JP-A-2003-72964, the printing sheet set in the feed hopper is first transported to a position of the paper transport roller by the feed roller connected to the paper transporting motor. When the printing sheet is transported to the position of the paper transport roller, the paper transporting motor is detached from the feed roller and then the printing sheet is subsequently transported by the paper transport roller.

In the printer described in JP-A-2006-117385, the feed roller and the paper transport roller are rotationally driven by separate motors. That is, the feed roller is rotationally driven by a paper feeding motor and the paper transport roller is rotationally driven by a paper transporting motor. In the printer described in JP-A-2006-117385, similar to the printer described in JP-A-2003-72964, a printing sheet is transported to a position of the paper transport roller by the feed roller and then the printing sheet is subsequently transported by the paper transport roller.

In the recent market of printers, the enhancement in through put (number of printed sheets per unit time) in a continuous printing operation of continuously performing a printing operation on a plurality of printing sheets was required. However, in the printers described in JP-A-2003-72964 and JP-A-2006-117385, a printing sheet is fed to a position of the paper transport roller by the feed roller and then the printing sheet is subsequently transported by the paper transport roller. That is, a printing operation or a paper discharging operation is independent of a paper feeding operation. Accordingly, in the printers described in JP-A-2003-72964 and JP-A-2006-117385, the enhancement in throughput is restricted.

### SUMMARY

An advantage of some aspects of the invention is to provide a printer having a configuration which can enhance a throughput and to provide a method of controlling a printer which can enhance a throughput.

According to an aspect of the invention, there is provided a printer for performing a printing operation on a printing medium, the printer comprising:

a feed roller, operable to feed the printing medium from a medium setting portion in which the printing medium is set;

a feeding motor, operable to drive the feed roller;

a transport roller, operable to transport the printing medium fed from the medium setting portion;

a transporting motor, operable to drive the transport roller; and

a controller, operable to control the transporting motor based on a first speed profile indicating a relationship between a rotation time or a rotation distance and a target peripheral speed of the transport roller, and to control the feeding motor based on a second speed profile indicating a relationship between a rotation time or a rotation distance and a target peripheral speed of the feed roller and being substantially equal to the first speed profile.

The present disclosure relates to the subject matter contained in Japanese patent application No. 2006-201669 filed on Jul. 25, 2006, which is expressly incorporated herein by reference in its entirety.

### BRIEF DESCRIPTION OF THE DRAWINGS

The invention will be described with reference to the accompanying drawings, wherein like numbers reference like elements.

FIG. 1 is a partial side view schematically illustrating a configuration of a printer according to an embodiment of the invention.

FIG. 2 is a diagram schematically illustrating a configuration of a driving system including a PF driving roller shown in FIG. 1.

FIGS. 3A and 3B are diagrams illustrating operations of a rear feed hopper and a retard roller shown in FIG. 1.

FIG. 4 is a block diagram schematically illustrating configuration of a controller and peripheral devices thereof shown in FIG. 2.

FIG. 5 is a block diagram schematically illustrating a partial inner configuration of a DC unit shown in FIG. 4.

FIGS. 6A, 6B and 6C are diagrams illustrating a transport control method of a printing sheet P at the time of performing a continuous printing operation in a normal print mode.

FIG. 7 is a table schematically illustrating an example of a target speed table stored in a ROM shown in FIG. 4.

FIG. 8 is a graph illustrating speed profiles of a PF driving roller and a rear feed roller, which are prepared based on the target speed table shown in FIG. 7.

FIG. 9 is a graph illustrating a relationship between a rotation speed and a rotation time of the respective rollers when one printing sheet is transported by both the Pr driving roller and the rear feed roller.

FIGS. 10A, 10B, 10C and 10D are diagrams illustrating a control method of transporting a first printing sheet at the time of performing a continuous printing operation in a draft print mode.

FIGS. 11A, 11B and 11C are diagrams illustrating a control method of transporting two continuous printing sheets P at the time of performing the continuous printing operation in the draft print mode.

FIGS. 12A and 12B are diagrams illustrating a control method of transporting a final printing sheet at the time of performing the continuous printing operation in the draft print mode.

FIG. 13 is a flowchart illustrating a flow of the transport control of a printing sheet.

FIG. 14 is a graph illustrating another example of a relationship between the rotation speed and the rotation time of the respective rollers when one printing sheet is transported by both the PF driving roller and the rear feed roller.

### DESCRIPTION OF EXEMPLARY EMBODIMENTS

Hereinafter, a printer and a method of controlling the printer according to an embodiment of the invention will be described with reference to the drawings.

(Configuration of Printer)

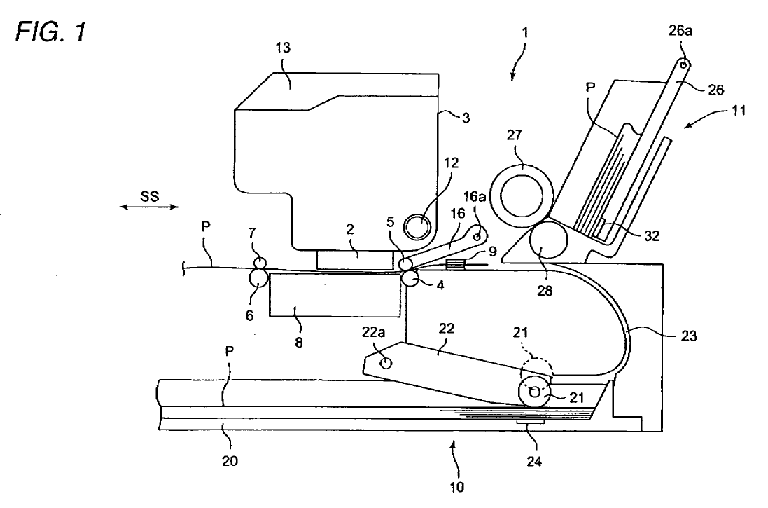

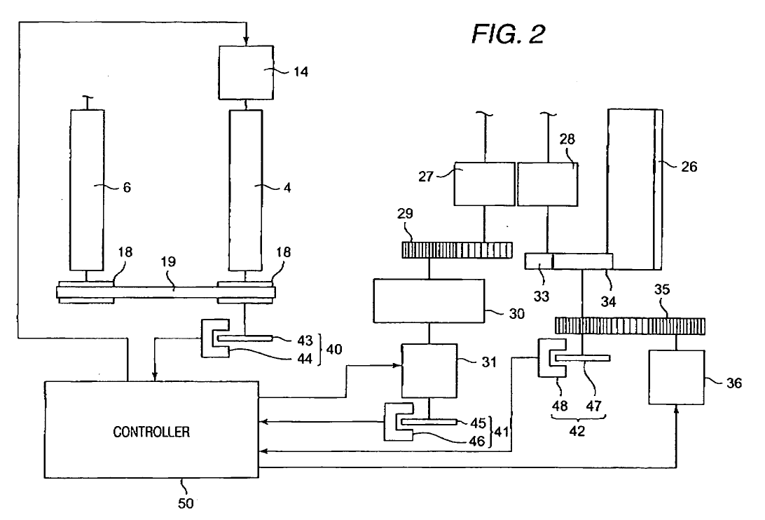

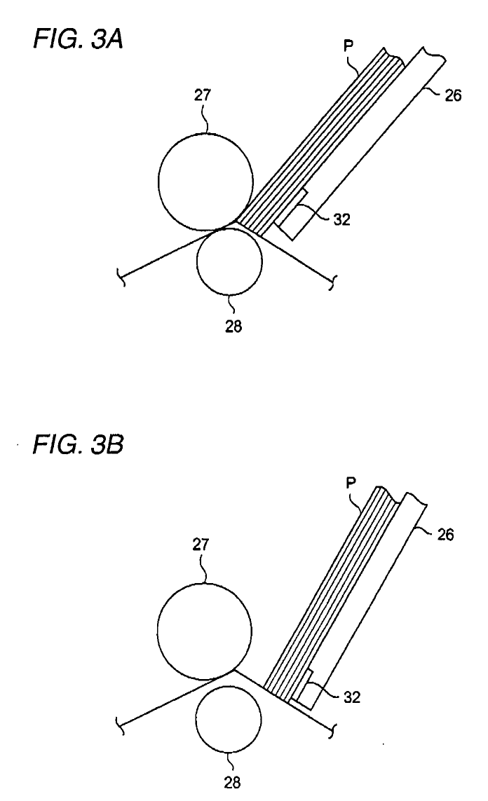

FIG. 1 is a partial side view schematically illustrating a configuration of a printer 1 according to an embodiment of the invention. FIG. 2 is a diagram schematically illustrating a configuration of a driving system including a PF driving roller 4 shown in FIG. 1. FIGS. 3A and 3B are diagrams illustrating operations of a rear feed hopper 26 and a retard roller 28 shown in FIG. 1, where FIG. 3A shows a state where the lower end of the rear feed hopper 26 and the retard roller 28 go up so as to enable a supply of a printing sheet P into the printer 1 and FIG. 3B shows a state where the lower end of the rear feed hopper 26 and the retard roller 28 go down so as to disable the supply of a printing medium P into the printer 1.

The printer 1 according to this embodiment is an ink jet printer for performing a printing operation by ejecting ink droplets to a printing sheet P as a printing medium and is configured to supply the printing sheet P from both sides of a front side (the left side in FIG. 1) and a rear side (the right side in FIG. 1), as shown in FIG. 1. The printer 1, as shown in FIG. 1, includes a carriage 3 mounted with a print head 2 for ejecting ink droplets, a PF driving roller 4 for transporting a printing sheet P supplied from a front feed cassette 20 or a rear feed hopper 26 to be described later in a sub scanning direction SS, a PF follower roller 5 for transporting the printing sheet P in cooperation with the PF driving roller 4, a discharge driving roller 6 as a medium discharge roller for discharging the printing sheet P from the printer 1, a discharge follower roller 7 for discharging the printing sheet P in cooperation with the discharge driving roller 6, a platen 8 opposed to an ink ejection surface (lower surface in FIG. 1) of the print head 2, a paper detector 9 for detecting a pass of the printing sheet P supplied from the rear feed hopper 26 or the like, a front feed mechanism 10 for supplying the printing sheet P from the front side to a print area on which a printing operation is performed by the print head 2, and a rear feed mechanism 11 for supplying the printing sheet P from the rear side to the print area. The printing medium of this embodiment includes a transparent film such as a seal or an OHP film, in addition to a sheet of regular paper used for a regular document print, a sheet of photo paper used for a photo print, and a paperboard thicker than the regular paper and the photo paper.

The carriage 3 is connected to a carriage motor (CR motor) not shown through a belt or a pulley not shown. The carriage 3 is driven by the CR motor, is guided by a guide shaft 12, and moves in a main scanning direction (a direction perpendicular to the paper surface of FIG. 1). An ink cartridge 13 in which a variety of ink to be supplied to the print head 2 is received is mounted on the carriage 3. An end detector (not shown) for detecting an end of a printing sheet P is attached to the carriage 3.

The surface of the PF driving roller 4 is coated with a high frictional material having a high frictional coefficient. As shown in FIG. 2, the PF driving roller 4 is connected to a feed motor (PF motor) 14 as directly or through a gear not shown. The PF motor 14 in this embodiment is a DC (direct current) motor. In this embodiment, a method of controlling the PF motor 14 employs PWM (Pulse Width Modulation) control which is one kind of voltage control and PID control for converging a current rotation speed of the PF motor 14 to a target rotation speed in combination of proportional control, integral control, and derivative control.

As shown in FIG. 1, the PF follower roller 5 is rotatably held on the discharge side of a follower roller holder 16 which is pivotable about a rotation pivot 16a. The follower roller holder 16 is urged in the counterclockwise direction in the figure so that an urging force toward the PF driving roller 4 is always applied to the PF follower roller 5 always receives by a spring not shown. When the PF driving roller 4 is driven, the PF follower roller 5 also rotates with the rotation of the PF driving roller 4. As shown in FIG. 1, the PF follower roller 5 and the PF driving roller 4 are disposed closer to the rear side than the print head 2 is.

As shown in FIG. 2, the discharge driving roller 6 is connected to the PF driving roller 4 through a transmission mechanism such as a pulley 18 and a belt 19. That is, the discharge driving roller 6 is driven by the PF motor 14. The rotation of the discharge driving roller 6 is synchronized with the rotation of the PF driving roller 4. That is, the discharge driving roller 6 rotates substantially at the same peripheral speed as the peripheral speed of the PF driving roller 4. An urging force toward the discharge driving roller 6 is always applied to the discharge follower roller 7 by a spring not shown, similarly to the PF follower roller 5. When the discharge driving roller 6 is driven, the discharge follower roller 7 rotates along with the discharge driving roller 6. As shown in FIG. 1, the discharge driving roller 6 and the discharge follower roller 7 are disposed closer to the front side (discharge side) than the print head 2 is.

The paper detector 9 is an optical detector in which a light-emitting element and a light-receiving element not shown are disposed vertically opposite each other. The paper detector 9 detects an end in the width direction of the printing sheet P passing through the light-emitting element and the light-receiving element. The paper detector 9 is disposed between the PF driving roller 4 and the rear feed mechanism 11 which are arranged closer to the rear side than the carriage 3 is. At the time of performing a continuous printing operation on the printing sheets P, the trailing end of a preceding printing sheet P and the leading end of a subsequent printing sheet P can be detected by the paper detector 9.

The front feed mechanism 10 includes a front feed cassette 20 in which non-printed printing sheets P to be supplied from the front side are set, a front feed roller 21 that feeds the printing sheets P set in the front feed cassette 20 into the printer 1 (that is, toward a printing area on which a printing operation is performed by the print head 2), an arm 22 that rotatably holds the front feed roller 21, and a transport passage 23 through which the printing sheet P entering the front feed roller 21 passes. In this embodiment, as shown in FIG. 1, the printing sheet P fed from the front side is first transported toward the rear side, is then inverted in the transport direction by the transport passage 23 formed in a substantially circular-arc shape, and is transported to the front side.

A frictional member 24 made of a material having a relatively high frictional coefficient such as cork is attached to the bottom surface of the front feed cassette 20. The frictional member 24 serves to prevent a double feed of the printing sheets P (a phenomenon that plurality printing sheets P are fed from the front feed cassette 20 at a time). The front feed roller 21 is attached to an end of the arm 22 which is pivotable about the rotation pivot 22a. The front feed roller 21 comes in contact with the top surface of the printing sheet P, as indicated by a solid line in FIG. 1, when a printing sheet is fed from the front side, and gets separated from the top surface of the printing sheet P, as indicated by an alternate long and two short dashes line in FIG. 1, when no printing sheet is fed from the front side. The front feed roller 21 transports the printing sheet P inside the printer 1, until the leading end of the printing sheet P reaches the PF driving roller 4 and the PF follower roller 5. When the leading end of the printing sheet P reaches the PF driving roller 4, the front feed roller 21 gets separated from the top surface of the printing sheet P and then the printing sheet P is transported by the PF driving roller 4, the PF follower roller 5, the discharge driving roller 6, and the discharge follower roller 7. The front feed roller 21 may always be in contact with the top surface of the printing sheet P set in the front feed cassette 20.

The rear feed mechanism 11 includes a rear feed hopper 26 in which non-printed printing sheets P to be fed from the rear side are set, a rear feed roller 27 that feeds the printing sheets P set in the rear feed hopper 26 into the printer 1 (that is, toward the printing area on which a printing operation is performed by the print head 2), and a retard roller 28 serving to prevent a double transport of the printing sheets P (a phenomenon that plurality printing sheets P are fed from the rear feed hopper 26 at a time).

The rear feed roller 27 is connected to an ASF motor 31 through a gear train 29 and a planet gear train 30, as shown in FIG. 2. The front feed roller 21 is also connected to the ASF motor 31 through the planet gear train 30 and the like (the front feed roller 21 is not shown in FIG. 2). In this embodiment, when the ASF motor 31 rotates in one direction, the rear feed roller 27 rotates by means of the action of the planet gear train 30 and the printing sheet P is fed into the printer 1 from the rear side. When the ASF motor 31 rotates in the opposite direction, the front feed roller 21 rotates by means of the action of the planet gear train 30 and the printing sheet P is fed into the printer 1 from the front side.

The ASF motor 31 of this embodiment is a DC motor. In this embodiment, similarly to the PF motor 14, a method of controlling the ASF motor 31 employs PWM control which is one kind of voltage control and PID control for converging a current rotation speed of the ASF motor 31 to a target rotation speed in combination of proportional control, integral control, and derivative control.

As shown in FIG. 1, the rear feed hopper 26 is a plate-like member on which a printing sheet P can be placed and is pivotable about the rotation pivot 26a disposed at the upper end. A frictional member 32 made of a material having a relatively high frictional coefficient such as cork is attached to the lower end of a surface of the rear feed hopper 26 on which the printing sheet P is placed. The frictional member 32 serves to prevent the double transport of the printing sheet P along with the retard roller 28.

The retard roller 28 is disposed at a position opposed to the lower side of the slope of the rear feed roller 27. The outer periphery of the retard roller 28 is made of a member having a high frictional coefficient. The retard roller 28 is rotatably held by an arm which is pivotable about a predetermined rotation pivot (not shown), as shown in FIG. 2.

The rear feed hopper 26 pivots about the rotation pivot 26a by means of the rotational motion of a cam 34 schematically shown in FIG. 2. The lower end of the rear feed hopper 26 is urged to the rear feed roller 27 or gets separated from the rear feed roller 27 by means of the pivoting. The arm 33 holding the retard roller 28 also pivots by means of the rotational motion of the cam 34. The retard roller 28 comes in contact with the rear feed roller 27 or gets separated from the rear feed roller 27.

Specifically, as shown in FIG. 2, when the cam 34 connected to an ASF sub motor 36 via a gear train 35 is driven to rotate by a predetermined amount (predetermined angle) by the ASF sub motor 36, the lower end of the rear feed hopper 26 and the retard roller 28 rise as shown in FIG. 3A. That is, the lower end of the rear feed hopper 26 is urged to the rear feed roller 27 and the retard roller 28 comes in contact with the rear feed roller 27. In this state, when the cam 34 rotates again by a predetermined amount, the lower end of the rear feed hopper 26 and the retard roller 28 lowers as shown in FIG. 3B. That is, the lower end of the rear feed hopper 26 gets separated from the rear feed roller 27 and the retard roller 28 also gets separated from the rear feed roller 27. The ASF motor 36 of this embodiment is a DC motor.

The state shown in FIG. 3A is a state where the printing sheet P can be fed into the printer 1. When the rear feed roller 27 rotates in this state, the uppermost printing sheet P of the printing sheets P placed on the rear feed hopper 26 passes through a nip portion between the rear feed roller 27 and the retard roller 28 and is transported to the discharge side. The next printing sheets P are prevented from being transported to the discharge side by means of the operation of the retard roller 28. The state shown in FIG. 3B is a state where no printing sheet P can be fed into the printer 1 from the rear side.

The printer 1 according to this embodiment includes a PF encoder 40 for detecting a rotation distance (rotational position) and a rotation speed of the PF motor 14, an ASF encoder 41 for detecting a rotation distance (rotational position) and a rotation speed of the ASF motor 31, and a position detector 42 for detecting a rotational position of the cam 34, as shown in FIG. 2.

The PF encoder 40 includes a rotary scale 43 fixed to the rotation axis of the PF driving roller 4 and a photo sensor 44 having a light-emitting element and a light-receiving element (not shown) with the outer periphery of the rotary scale 43 interposed therebetween. The output signal from the PF encoder 40 is input to the controller 50 for variously controlling the printer 1. The rotary scale 43 is formed in a disc shape, for example, out of a transparent plastic thin plate. Plural marks (not shown) are arranged at a constant pitch in the peripheral direction on the peripheral edge of the rotary scale 43. Specifically, a black color is printed at a constant interval in the peripheral direction along the outer periphery of one surface of the rotary scale 43 and the portions in which the black color is printed are the marks. The rotary scale 43 is formed of a thin stainless steel plate or the like and slits penetrating the rotary scale 43 instead of the marks may be formed in the rotary scale 43.

The ASF encoder 41 includes a rotary scale 45 fixed to the output axis of the ASF motor 31 and a photo sensor 46 having a light-emitting element and a light-receiving element not shown with the outer periphery of the rotary scale 45 interposed therebetween. The output signal from the ASF encoder is input to the controller 50. Similarly to the rotary scale 43, the rotary scale 45 is formed of a transparent plastic thin plate or a stainless steel thin plate and marks or slits are formed in the rotary scale 45.

The position detector 42 includes a detection plate 47 fixed to the rotation axis of the cam 34 and a photo sensor 48 having a light-emitting element and a light-receiving element not shown with the outer periphery of the detection plate 47 interposed therebetween. The output signal from the position detector 42 is input to the controller 50.

[Configuration of Controller]

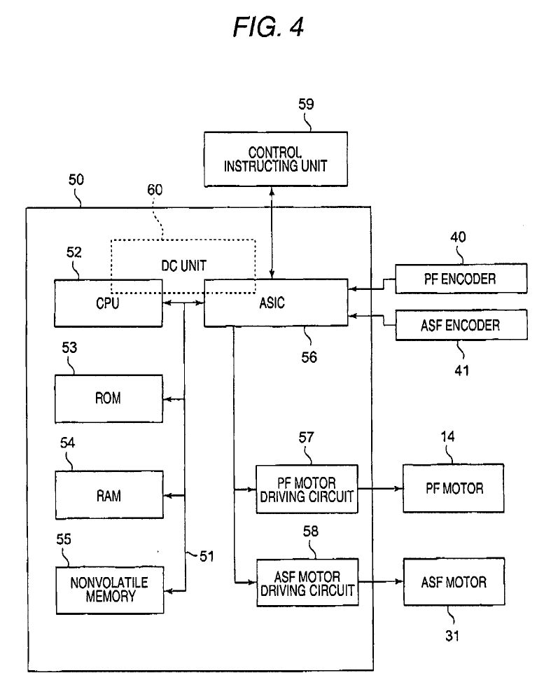

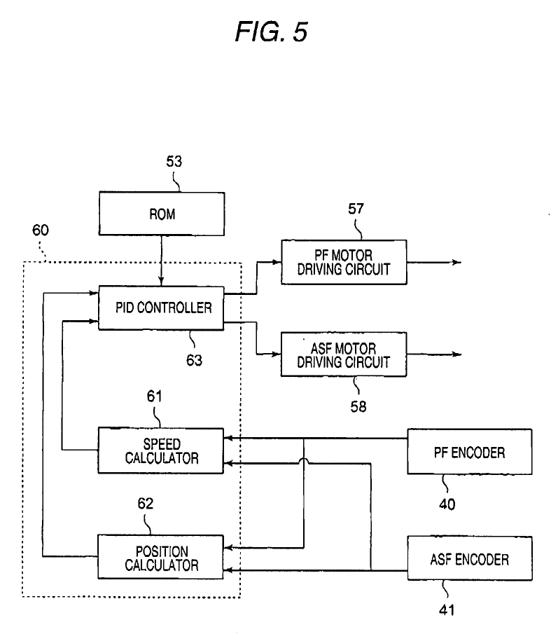

FIG. 4 is a block diagram schematically illustrating a configuration of the controller 50 shown in FIG. 2 and the peripheral devices thereof. FIG. 5 is a block diagram schematically illustrating a part of an inner configuration of a DC unit shown in FIG. 4. FIGS. 4 and 5 show only configurations of the controller 50 corresponding to the control of the PF motor 14 and the ASF motor 31.

As shown in FIG. 4, the controller 50 includes a bus 51, a CPU 52, a ROM 53, a RAM 54, a nonvolatile memory 55, an ASIC 56, a PF motor driving circuit 57, and an ASF motor driving circuit 58.

The CPU 52 performs calculation processes for executing control programs of the printer 1 stored in the ROM 53 and the nonvolatile memory 55 and other necessary calculation processes. The control programs for controlling the printer 1 and data necessary for the processes are stored in the ROM 53. For example, a target speed table in which target rotation speeds corresponding to the rotation time or the rotation distance of the PF motor 14 used in the PID control are set or a target speed table in which target rotation speeds corresponding to the rotation time or the rotation distance of the ASF motor 31 are set is stored in the ROM 53, as described later. Programs under execution and data under calculation by the CPU 52 are temporarily stored in the RAM 54. A variety of data to be stored after the printer 1 is turned off are stored in the nonvolatile memory 55.

As shown in FIG. 4, various signals from the PF encoder 40, the ASF encoder 41, and the like are input to the ASIC 56. The ASIC 56 supplies the PF motor driving circuit 57 or the ASF motor driving circuit 58 with the signals for controlling various motors such as the PF motor 14 and the ASF motor 31. The ASIC 56 has an interface circuit built therein so as to receive print signals supplied from the control instruction unit 59.

The speeds and the like of the PF motor 14 and the ASF motor 31 are controlled by combination of the CPU 52 and the ASIC 56. That is, a DC unit 60 as a control circuit for controlling the speeds and the like of the PF motor 14 and the ASF motor 31 which are DC motors is constituted by a part of the CPU 52 and a part of the ASIC 56. Specifically, in the DC unit 60, a part of the CPU 52 performs a variety of calculations for controlling the speeds and the like of the PF motor 14 and the ASF motor 31 on the basis of various signals input from the PF encoder 40 or the ASF encoder 41 through the ASIC 56. In the DC unit 60, a part of the ASIC 56 receives signals from the PF encoder 40 or the ASF encoder 41 or outputs signals to the PF motor driving circuit 57 and the ASF motor driving circuit 58 on the basis of the calculation result of the CPU 52.

As described above, the PF motor 14 and the ASF motor 31 of this embodiment are controlled in the PID control manner. Accordingly, the DC unit 60 includes a speed calculator 61, a position calculator 62, and a PID controller 63 for performing the PID control, as shown in FIG. 5, when it is schematically shown.

The speed calculator 61 calculates a current rotation speed of the PF motor 14 on the basis of the signal input from the PF encoder 40 and outputs a signal corresponding to the rotation speed to the PID controller 63. The speed calculator 61 calculates a current rotation speed of the ASF motor 31 on the basis of the signal input from the ASF encoder 41 and outputs a signal corresponding to the rotation speed to the PID controller 63.

The position calculator 62 calculates a current rotation distance of the PF motor 14 on the basis of the signal input from the PF encoder 40 and outputs a signal corresponding to the rotation distance to the PID controller 63. The position calculator 62 calculates a current rotation distance of the ASF motor 31 on the basis of the signal input from the ASF encoder 41 and outputs a signal corresponding to the rotation distance to the PID controller 63.

The PID controller 63 calculates a positional difference between a target stop position and the current rotation distance on the basis of a signal of the target stop position corresponding to a next stop position of the printing sheet P and being output from the ROM 53 and a signal of the current rotation distance input from the position calculator 62. Thereafter, the PID controller 63 reads out a target rotation speed corresponding to the current rotation distance of the PF motor 14 or the ASF motor 31 from the target speed table stored in the ROM 53 on the basis of the signal of the positional difference. Thereafter, the PID controller 63 calculates a proportional control value, an integral control value, and a derivative control value on the basis of the speed difference and adds the control values to output a PID control signal. In this embodiment, as described above, since the PF motor 14 and the ASF motor 31 are controlled in the PWM control manner, the PID control signal is a pulse-like signal in which ON and OFF states are repeated at a predetermined switching period.

The PF motor driving circuit 57 controls the P motor 14 on the basis of the signal form the DC unit 60 (specifically the signal from the ASIC 56). In this embodiment, since the PF motor 14 is controlled in the PWM control manner, the PF motor driving circuit 57 outputs a PWM driving signal. Similarly, since the ASF motor driving circuit 58 controls the ASF motor 31 on the basis of the signal form the DC unit 60, it outputs a PWM driving signal.

The bus 51 is a signal line connecting the elements of the above-mentioned controller 50 to each other. The CPU 52, the ROM 53, the RAM 54, the nonvolatile memory 55, and the ASIC 56 are connected to each other through the bus 51 so as to transmit and receive data.

[Schematic Operation of Printer]

In the printer 1 having the above-mentioned configuration, the printing sheet P fed into the printer 1 from the front feed cassette 20 by the front feed roller 21 or the printing sheet P fed into the printer 1 from the rear feed hopper 26 by the rear feed roller 27 is intermittently transported in the sub scanning direction SS by the PF driving roller 4 and the like. When the intermittent transport is stopped, the carriage 3 reciprocates in the main scanning direction. When the carriage 3 reciprocates, ink droplets are ejected from the print head 2 to perform a printing operation on the printing sheet P. When the printing operation on the printing sheet P is ended, the printing sheet P is discharged from the printer 1 by the discharge driving roller 6 and the like.

When the PF driving roller 4 rotates (that is, when the PF motor 14 rotates), a signal is output from the PF encoder 40. The signal is input to the controller 50 and the controller 50 detects the rotation distance and the rotation speed of the PF driving roller 4 (that is, the rotation distance and the rotation speed of the PF motor 14) from the input signal. The controller 50 performs various control operations on the printer 1 on the basis of the detected rotation distance (rotational position) and the detected rotation speed of the PF motor 14. Similarly, when the rear feed roller 27 rotates (that is, when the ASF motor 31 rotates), a signal from the ASF encoder 41 is input to the controller 50 and the controller 50 detects the rotation distance and the rotation speed of the rear feed roller 27 (that is, the rotation distance and the rotation speed of the ASF motor 31) from the input signal. The controller 50 performs various control operations on the printer 1 on the basis of the detected rotation distance (rotational position) and the detected rotation speed of the ASF motor 31.

In this embodiment, at the time of continuously performing a printing operation on a plurality of printing sheets P, a method of controlling the PF motor 14 and the ASF motor 31 in a draft print mode (economy print mode) in which a high-speed printing operation is performed by saving ink consumption instead of lowering the resolution is different from a method of controlling the PF motor 14 and the ASF motor 31 in a print mode (hereinafter, referred to as normal print mode) in which a printing operation is performed with a resolution higher than a predetermined value and which is other than the draft print mode. That is, the controller 50 switches the control operation between the transport control of the printing sheet P in the draft mode and the transport control of the printing sheet P in the normal print mode at the time of performing the continuous printing operation. A method of controlling a transport of a printing sheet P in the printer 1 (that is, a method of controlling the PF motor 14 and the ASF motor 31) will be described now with reference to a case where the printing sheet P is fed into the printer 1 from the rear side.

[Transport Control Method of Printing Sheet]

(Control Method in Normal Print Mode)

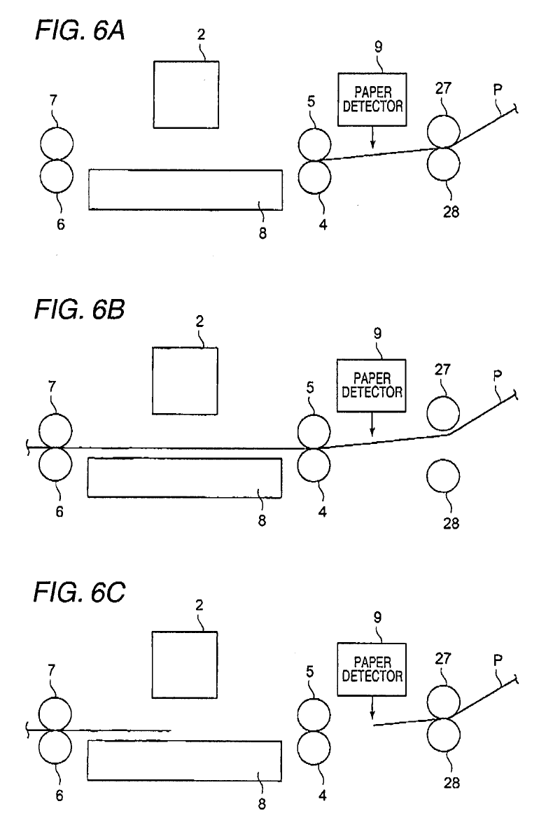

FIGS. 6A, 6B and 6C are diagrams illustrating a transport control method of a printing sheet P at the time of performing a continuous printing operation in the normal print mode according to an embodiment of the invention, where FIG. 6A shows a state where the first printing sheet P is fed, FIG. 6B shows a state where the printing sheets P are intermittently transported during performing a printing operation on the printing sheets P, and FIG. 6c shows a state where the printing operation on the preceding printing sheet P is ended and a subsequent printing sheet P is fed.

In the normal print mode according to this embodiment, the printing sheets P set in the rear feed hopper 26 is first fed and transported to the PF driving roller 4 by the rear feed roller 27 and then is transported by the PF driving roller 4 and the discharge driving roller 6. That is, in the normal print mode, the PF motor 14 and the ASF motor 31 are separately controlled to transport the printing sheet P. Hereinafter, such transport control of a printing sheet P is referred to as separate transport control.

Specifically, first as shown in FIG. 3A, the ASF motor 31 is driven to rotate the rear feed roller 27 in a state where the lower end of the rear feed hopper 26 is urged to the rear feed roller 27 and the retard roller 28 comes in contact with the rear feed roller 27. Then, as shown in FIG. 6A, the leading end of the printing sheet P is transported to the position where the PF driving roller 4 and the PF follower roller 5 are disposed by the rear feed roller 27 and thus the printing sheet P is fed into the printer 1.

When the leading end of the printing sheet P is transported to the position of the PF driving roller 4 and the PF follower roller 5, the lower end of the rear feed hopper 26 is separated from the rear feed roller 27 and the retard roller 28 is also separated from the rear feed roller 27, as shown in FIGS. 3B and 6B. The ASF motor 31 is stopped to stop the rotation of the rear feed roller 27. In this state, the PF motor 14 is intermittently driven to intermittently transport the printing sheet P by the use of the PF driving roller 41 and ink droplets are ejected onto the print sheet P from the print head 2. After the leading end of the printing sheet P reaches the position of the discharge driving roller 6 and the discharge follower roller 7, the printing sheet P is intermittently transported by the PF driving roller 4 and the discharge driving roller 6. In the normal print mode, a head positioning of a printing sheet P of positioning the leading end of the printing sheet P and the print head 2 relative to each other by the use of an end detector attached to the carriage 3.

When the printing operation on the printing sheet P is finished, the PF motor 14 is continuously driven, as shown in FIG. 6C, and the printing sheet P is discharged from the printer 1 by the discharge driving roller 6. After discharging the preceding printing sheet P or in the course of discharging the preceding printing sheet P, the lower end of the rear feed hopper 26 and the retard roller 28 rise and the ASF motor 31 is driven to rotate the rear feed roller 27. As shown in FIG. 6C, the printing sheet P is transported and fed to the position of the PF driving roller 4 and the PF follower roller 5 by the rear feed roller 27.

In the normal print mode, the PF motor 14 and the ASF motor 31 are independently set and are independently controlled in the PID control manner on the basis of the separated target speed tables stored in the ROM 53. At the time of a single sheet printing operation of performing the printing operation on only one printing sheet P1, the printing sheet P set in the rear feed hopper 26 is first transported and fed to the PF driving roller 4 by the rear feed roller 27 and is then transported by the PF driving roller 4, regardless of the draft print mode or the normal print mode. That is, the separate transport control is performed in the single sheet printing operation.

(Control Method in Draft Print Mode)

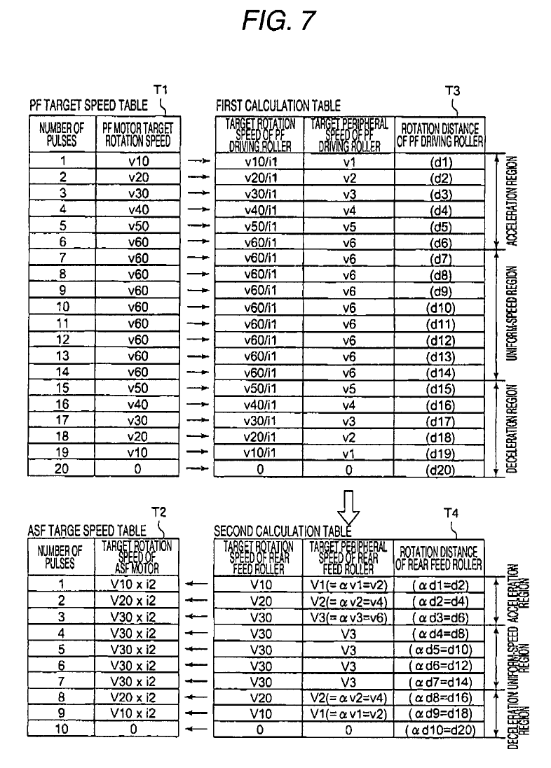

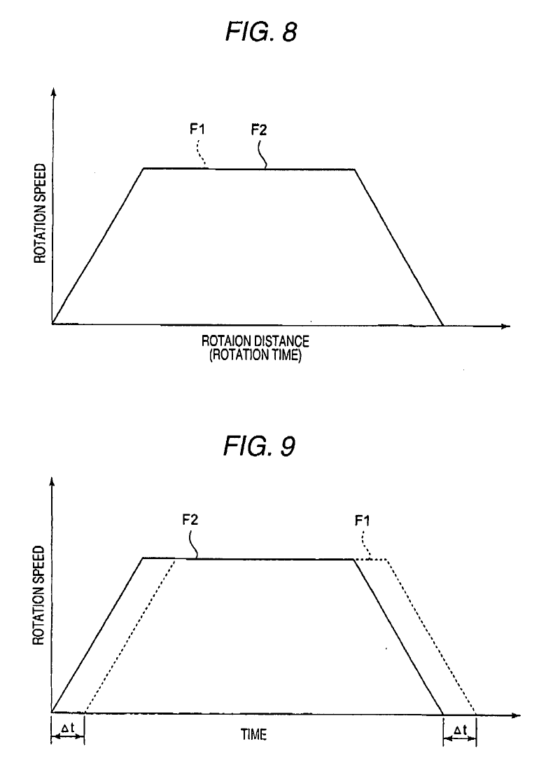

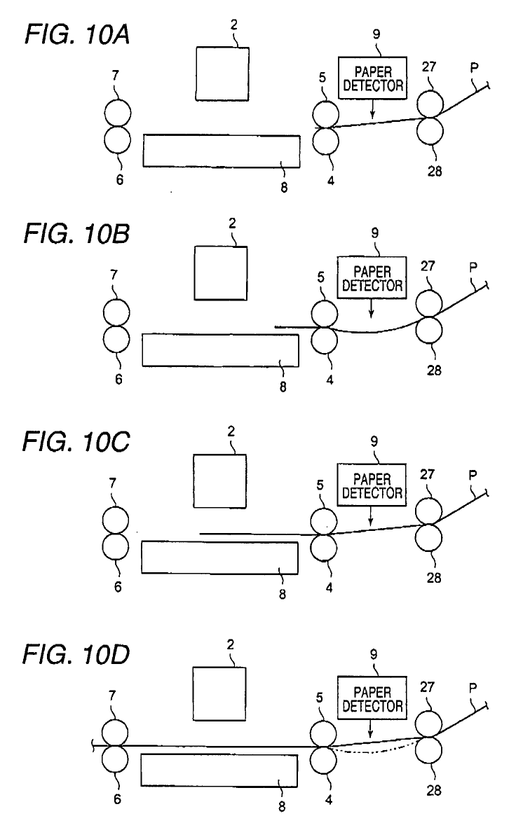

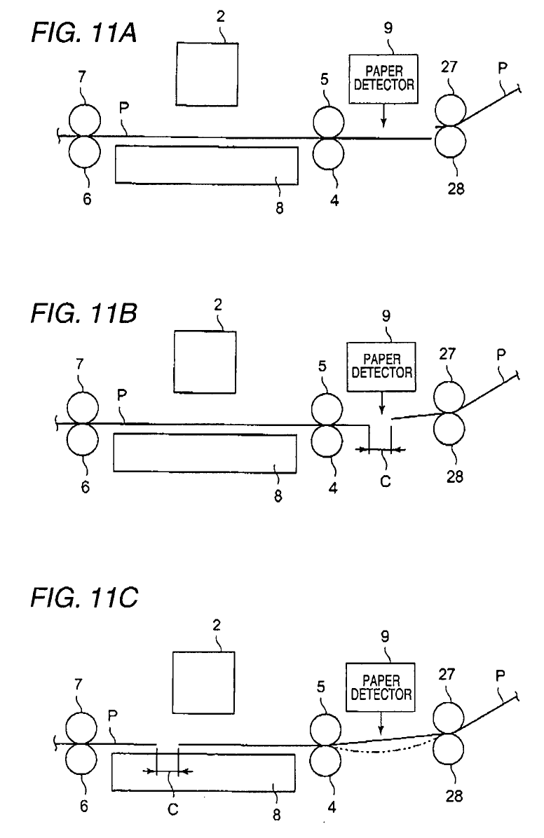

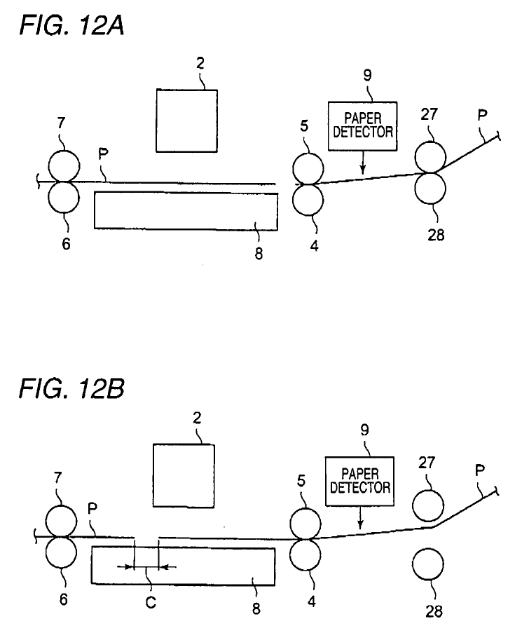

FIG. 7 is a table schematically illustrating an example of a target speed table stored in the ROM 53 shown in FIG. 4. FIG. 8 is a graph illustrating speed profiles F1 and F2 of the PF driving roller 4 and the rear feed roller 27, which are prepared based on the target speed table shown in FIG. 7. FIG. 9 is a graph illustrating a relationship between the rotation speed and the rotation time of the respective rollers when one printing sheet P is transported by both the PF driving roller 4 and the rear feed roller 27. FIGS. 10A, 10B, 10C and 10D are diagrams illustrating the control method of transporting a first printing sheet at the time of performing a continuous printing operation in the draft print mode. FIGS. 11A, 11B and 11C are diagrams illustrating the control method of transporting two continuous printing sheets P at the time of performing the continuous printing operation in the draft print mode. FIGS. 12A and 12B are diagrams illustrating the control method of transporting a final printing sheet at the time of performing a continuous printing operation in the draft print mode.

FIG. 10A shows a state where the printing sheet P is fed, FIG. 10B shows a state where the fed printing sheet P is transported to the position of the print head 2 by both the PF driving roller 4 and the rear feed roller 27, FIG. 10C shows a state where one printing sheet P transported by both the PF driving roller 4 and the rear feed roller 27 is transported to and stopped at the position of the print head 2, and FIG. 10D shows a state where the printing sheet P is intermittently transported at the time of performing a printing operation on the printing sheet P. FIG. 11A shows a state where the trailing end of the preceding printing sheet P leaves the rear feed roller 27 and the transport of the subsequent printing sheet P is started by the rear feed roller 27, FIG. 11B shows a state where the trailing end of the preceding printing sheet P and the leading end of the subsequent printing sheet P are located between the PF driving roller 4 and the rear feed roller 27, and FIG. 11C shows a state where one printing sheet P transported by both the PF driving roller 4 and the rear feed roller 27 is transported to the position of the print head 2. FIG. 12A shows a state where the leading end of the final printing sheet P is transported to the position of the PF driving roller 4 and FIG. 12B shows a transport state of the printing sheet P after the leading end of the final printing sheet P is transported to the position of the PF driving roller 4.

In the draft print mode of this embodiment, the rear feed roller 27 in addition to the PF driving roller 4 and the discharge driving roller 6 is used to transport the printing sheet P after it is transported to the PF driving roller 4 from the rear feed hopper 26 by the rear feed roller 27. That is, in the draft print mode, the PF driving roller 4 and the discharge driving roller 6 which are driven by the PF motor 14 transport the printing sheet P in the printing operation, in cooperation with the rear feed roller 27 which is driven by the ASF motor 31. Accordingly, in the draft print mode, it is necessary to allow the PF driving roller 4 and the discharge driving roller 6 to rotate in synchronization with the rear feed roller 27 (that is, at the same peripheral speed). Therefore, in the draft print mode of this embodiment, the PF motor 14 and the ASF motor 31 are controlled to transport the printing sheet P by the use of synchronization control which is a control operation for allowing the PF driving roller 4 and the discharge driving roller 6 to rotate in synchronization with the rear feed roller 27. Hereinafter, such an operation of controlling a transport of the printing sheet P is referred to as a synchronized transport control operation.

In the draft print mode of this embodiment, the synchronized transport control operation is performed. When one printing sheet P is transported by both the PF driving roller 4 and the rear feed roller 27, a start correction control operation of setting a time point for starting the PF motor 14 to be later than a time point for starting the ASF motor 31 is performed. In the draft print mode of this embodiment, the final printing sheet P in the continuous printing operation is transported and fed to the PF driving roller 4 by the rear feed roller 27 and is thereafter transported by the PF driving roller 4 and the discharge driving roller 6. That is, the final printing sheet P is transported under the separate transport control.

A method of controlling a transport of a printing medium P in a draft print mode will be described now in detail.

As described above, the PF motor 14 and the ASF motor 31 are controlled in the PID control manner. Accordingly, the ROM 53 stores, for example, a PF target speed table T1 as the first target speed table in which the target rotation speeds corresponding to the rotation time or the rotation distance of the PF motor 14 for performing a synchronization control process and stores, for example, an ASF target speed table T2 as the second target speed table in which target rotation speeds corresponding to the rotation time or the rotation distance of the ASF motor 31 for performing a synchronization control process (see FIG. 7). First, a method of setting the first target speed table and the second target speed table is described.

In this embodiment, the first target speed table and the second target speed table are set so that the first speed profile (for example, a PF speed profile F1 prepared on the basis of the PF target speed table T1) prepared on the basis of the first target speed table (for example, the PF target speed table T1) and indicating the relationship between the rotation time or the rotation distance and the target peripheral speed (the target transport speed of the printing medium P by the PF driving roller 4) of the PF driving roller 4 is substantially equal to the second speed profile (for example, a feed speed profile F2 prepared on the basis of the ASF target speed table T2) prepared on the basis of the second target speed table (for example, the ASF target speed table T2) and indicating the relationship between the rotation time or the rotation distance and the target peripheral speed (the target transport speed of the printing medium P by the rear feed roller 27) of the rear feed roller 27.

In this embodiment, the ASF target speed table T2 is set, for example, using the PF target speed table T1 as a reference. Specifically, the ASF target speed table T2 is set on the basis of a ratio α of a resolution of the PF encoder 40 and a resolution of the ASF encoder 41 and the first target speed table.

Here, the ratio α (=the resolution of the ASF encoder 41/the resolution of the PF encoder 40) of the resolution of the ASF encoder 41 to the resolution of the PF encoder 40 is calculated as follows. When it is assumed that the diameters of the PF driving roller 4 and the rear feed roller 27 are denoted by D1 and D2, respectively, the numbers of marks formed in the rotary scales 43 and 45 are denoted by N1 and N2, respectively, and a deceleration ratio from the PF motor 14 to the PF driving roller 4 and a deceleration ratio from the ASF motor 31 to the rear feed roller 27 are denoted by i1 and i2, respectively, the resolution of the PF encoder 40 relative to the rotation distance of the PF driving roller 4 is πD1/N1×i1). The resolution of the ASF encoder 41 relative to the rotation distance of the rear paper speed roller 27 is πD2/(N2×i2). Accordingly, the ratio α is α=(D2×N1×i1)/(D1×N2×i2).

In the following description, the ratio α is set to α=2, for the purpose of easily understanding the method of setting the ASF target speed table T2 according to this embodiment. That is, the rotation distance of the PF driving roller 4 (the transport distance of the printing sheet P by the PF driving roller 4) corresponding to one pulse of a pulse signal (hereinafter, referred to as “PF pulse signal”) input from the PF encoder 40 to the ASIC 56 in accordance with the pitch of the marks formed in the rotary scale 43 or generated by the ASIC 56 on the basis of the input signal from the PF encoder 40 is ½ of the rotation distance of the rear feed roller 27 (the transport distance of the printing sheet P by the rear feed roller 27) corresponding to one pulse of a pulse signal (hereinafter, referred to as “ASF pulse signal”) input from the ASF encoder 41 to the ASIC 56 in accordance with the pitch of the marks formed in the rotary scale 45 or generated by the ASIC 56 on the basis of the input signal from the ASF encoder 41. In other words, when the PF driving roller 4 and the rear feed roller 27 are made to rotate by the same distance (that is, when the rotations distances thereof are equal to each other), the number of pulses of the PF pulse signal is double the number of pulses of the ASF pulse signal.

The ASF target speed table T2 is set on the basis of the ratio α calculated as described above and the first target speed table T1 as follows. First, the PF target speed table T1 is set to rapidly transport the printing sheet P and to precisely stop the printing sheet. For example, as shown in FIG. 7, the target rotation speeds of the PF motor 14 corresponding to the rotation distances (for example, the numbers of pulses of the PF pulse signal) are set in the PF target speed table T1. In the example shown in FIG. 7, the rotation distance of the PF driving roller 4 (for example, the distance of the printing sheet P intermittently transported at the time of performing a printing operation) is a distance corresponding to the pulses of the PF pulse signal 20. A region where the number of pulses of the PF pulse signal is in the range of 1 to 6 is an acceleration region where the PF motor 14 (the PF driving roller 4 or the discharge driving roller 6) is accelerated for control, a region where the number of pulses is in the range of 7 to 14 is a uniform-speed region where the PF motor 14 is kept uniform for control, and a region where the number of pulses is in the range of 15 to 20 is a deceleration region where the PF motor 14 is decelerated for control.

Thereafter, for example, as shown in the first calculation table of FIG. 7, the target rotation speeds of the PF driving roller 4 corresponding to the numbers of pulses of the PF pulse signals are calculated from the PF target speed table T1 and the deceleration ratio i1. The target peripheral speeds of the PF driving roller 4 corresponding to the numbers of pulses of the PF pulse signals are calculated from the target rotation speed of the PF driving roller 4 and the diameter D1 of the PF driving roller 4. The first calculation table T3 is prepared for setting the ASF target speed table T2 but is not stored in the ROM 53.

As described above, since the ratio is α=2, the rotation distance corresponding to 20 pulses of the PF pulse signal is equal to the rotation distance corresponding to 10 pulses of the ASF pulse signal. That is, as shown in FIG. 7, the target rotation speeds of the ASF motor 4 corresponding to the numbers of pulses of 10 pulses of the ASF pulse signal are set in the ASF target speed table T2 corresponding to the PF target speed table T1. Specifically, for example, as shown in a second calculation table T4 of FIG. 7, the target peripheral speeds of the rear feed roller 27 corresponding to the numbers of pulses of the ASF pulse signal are calculated from the ratio α and the target peripheral speed of the PF driving roller 4 so that the target peripheral speed of the PF driving roller 4 and the target peripheral speed of the rear feed roller 27 are substantially equal to each other when the rotation distance of the PF driving roller 4 is equal to the rotation distance of the rear feed roller 27. That is, the target peripheral speeds of the rear feed roller 27 corresponding to the numbers of pulses of the ASF pulse signal are calculated so that the PF speed profile F1 is substantially equal to the feed speed profile F2. Thereafter, the target rotation speeds of the rear feed roller 27 corresponding to the numbers of pulses of the ASF pulse signal are calculated from the target peripheral speed of the rear feed roller 27 and the diameter D2 of the rear feed roller 27. The target rotation speeds of the ASF motor 4 corresponding to the numbers of pulses of the ASF pulse signal from the target rotation speeds and the deceleration ratio i2 of the rear feed roller 27, and is set in the ASF target speed table T2. Similarly to the first calculation table T3, the second calculation table T4 is prepared to set the ASF target speed table T2 and is not stored in the ROM 53.

The PF speed profile F1 prepared on the basis of the PF target speed table T1 set as described above and the feed speed profile F2 prepared on the basis of the ASF target speed table T2 are substantially equal to each other as shown in FIG. 8. In FIG. 8, the PF speed profile F1 indicated by a dashed line completely overlaps with the feed speed profile F2 indicated by a solid line.

In this embodiment, the PF motor 14 is controlled in the PID control manner on the basis of the PF target speed table T1 corresponding to the PF speed profile F1 and the ASF motor 31 is controlled in the PID control manner on the basis of the ASF target speed table T2 corresponding to the feed speed profile F2 substantially equal to the PF speed profile F1.

A synchronization control operation performed on the basis of the PF target speed table T1 and the ASF target speed table T2 stored in the ROM 53 will be described now in more details. First, the synchronous transport control when the first printing sheet P in a continuous printing operation is transported will be described.

When the first printing sheet P is fed into the printer 1, first, as shown in FIG. 3A, the ASF motor 31 is driven to rotate the rear feed roller 27 in the state where the lower end of the rear feed hopper 26 is urged to the rear feed roller 27 and the retard roller 28 comes in contact with the rear feed roller 27. At this time, the rear feed roller 27 is controlled in rotation on the basis of the feed profile F2. Then, as shown in FIG. 10A, the leading end of the printing sheet P is transported to the position of the PF driving roller 4 and the PF follower roller 5 by the rear feed roller 27, whereby the printing sheet P is fed into the printer 1.

The PF motor 14 is started at the same time as the start of the ASF motor 31 and thus the PF driving roller 4 and the discharge driving roller 6 rotate. Accordingly, the leading end of the printing sheet P properly enter between the PF driving roller 4 and the PF follower roller 5. At this time, the PF driving roller 4 is controlled in rotation on the basis of the PF speed profile F1. That is, the PF motor 14 is controlled in the PID control manner on the basis of the PF target speed table T1. In this way, when the first printing sheet P is fed into the printer 1, the synchronous transport control operation is performed in the draft print mode.

In the draft print mode, the synchronous transport control operation may not be performed when the first printing sheet P is fed into the printer 1. At the time of performing a continuous printing operation in the draft print mode, as shown in FIG. 3A, the lower end of the rear feed hopper 26 and the retard roller 28 are always in the rising state until the leading end of the final printing sheet P reaches the position of the PF driving roller 4 and the PF follower roller 5.

Thereafter, the printing sheet P is controlled in transport under the synchronous transport control operation. Specifically, the first printing sheet P is intermittently transported by the PF driving roller 4 controlled in rotation on the basis of the PF speed profile F1 and the rear feed roller 27 controlled in rotation on the basis of the feed speed profile F2. That is, the PF driving roller controlled in rotation on the basis of the PF speed profile F1 and the rear feed roller 27 controlled in rotation on the basis of the feed speed profile F2 transport the printing sheet P in cooperation with each other. In other words, the PF motor 14 controlled in the PID control manner on the basis of the PF target speed table T1 and the ASF motor 31 controlled in the PID control manner on the basis of the ASF target speed table T2 are intermittently driven. First, as shown in FIGS. 10B and 10C, the printing sheet P is transported so that the leading end of the printing sheet P reaches the position of the print head 2 by means of once transporting action. The head positioning of the printing sheet P performed in the normal print mode is not performed in the draft print mode.

As described above, in the draft print mode of this embodiment, a start correction control operation is performed when a printing sheet P is transported by both the PF driving roller 4 and the rear feed roller 27. That is, when the printing sheet P is inserted between the PF driving roller 4 and the PF follower roller 5 and is also inserted between the rear feed roller 27 and the retard roller 28, the start timing of the PF motor 14 is set later than the start timing of the ASF motor 31. Specifically, as schematically illustrated in FIG. 9, the start timing of the PF motor 14 controlled in the PID control manner on the basis of the PF target speed table T1 corresponding to the PF speed profile F1 is set later by Δt than the start timing of the ASF motor 31 controlled in the PID control manner on the basis of the ASF target speed table T2 corresponding to the feed profile F2.

Accordingly, the printing sheet P in transport is loosened between the PF driving roller 4 and the rear feed roller 27, as shown in FIG. 10B. The printing sheet P in stop has no looseness, as shown in FIG. 10C. In this embodiment, the leading end of the printing sheet P set in the rear feed hopper 26 is transported to the position of the PF driving roller or to the front of the position of the PF driving roller 4 by means of once transport action. Accordingly, for example, by allowing the paper detector 9 to detect the leading end of the printing sheet P, the printing sheet P is transported by the PF driving roller 4 and the rear feed roller 27 in the subsequent transporting operation. Therefore, the start correction control process is performed in the subsequent transporting operation.

Thereafter, when the printing sheet P is intermittently transported by the PF driving roller 4 and the rear feed roller 27 and the leading end thereof finally reaches the position of the discharge driving roller 6 and the discharge follower roller 7, the printing sheet P is intermittently transported by the PF driving roller 4, the discharge driving roller 6, and the rear feed roller 27, as shown in FIG. 10D. In the intermittent transporting operation, the PF driving roller 4 and the discharge driving roller 6 are controlled in rotation on the basis of the PF speed profile F1 and the rear feed roller 27 is controlled in rotation on the basis of the PF speed profile F2. That is, the synchronous transport control operation is performed. By means of the start correction control operation, the printing sheet P in transport is loosened between the PF driving roller 4 and the rear feed roller 27 and the printing sheet P in stop loses the looseness. The printing operation on the printing sheet P is performed at the time of stopping the printing sheet P.

Subsequently, the synchronous control operation at the time of continuously transporting two printing sheets P will be described.

As shown in FIG. 11A, when the trailing end of a preceding printing sheet P departs from the rear feed roller 27 and a subsequent printing sheet P is newly transported by the rear feed roller 27, the start timing of the PF motor 14 controlled in the PID control manner on the basis of the PF target speed table T1 is set to be equal to the start timing of the ASF motor 31 controlled in the PID control manner on the basis of the ASF target speed table T2. That is, the start correction control operation is not performed in the synchronous transport control operation at that time. Accordingly, when the synchronous transport control operation is performed, the trailing end portion of the preceding printing sheet P and the leading end portion of the subsequent printing sheet P can be prevented from overlapping with each other. It is recognized, for example, from the number of intermittent transports of the printing sheet P whether the trailing end of the preceding printing sheet P departs from the rear feed roller 27 and the transport of the subsequent printing sheet P is started by the rear feed roller 27. When the trailing end of the preceding printing sheet P departs from the rear feed roller 27 and the transport of the subsequent printing sheet P is started by the rear feed roller 27, the start correction control operation may be performed.

In this embodiment, when the trailing end of the preceding printing sheet P departs from the rear feed roller 27 and the transport of the subsequent printing sheet P is started by the rear feed roller 27, a slight slip is generated between the rear feed roller 27 and the retard roller 28 opposed to each other and the subsequent printing sheet P. Accordingly, as shown in FIG. 11B, a predetermined gap C is formed between the trailing end of the preceding printing sheet P and the leading end of the subsequent printing sheet P. The gap C is in the range of 1 mm to 5 mm.

Thereafter, as shown in FIG. 11C, when the subsequent printing sheet P is in the state where it is transported by both the PF driving roller 4 and the rear feed roller 27 (that is, the leading end of the printing sheet P reaches the position of the PF driving roller 4), the synchronous transport control operation is performed and the start correction control operation is performed again. If the subsequent printing sheet P is in the state where it is transported by both the PF driving roller 4 and the rear feed roller 27, it is recognized from whether the paper detector 9 detects the leading end of the printing sheet P.

Thereafter, the subsequent printing sheet P is intermittently transported by the PF driving roller 4 and the rear feed roller 27, as shown in FIG. 1C. When the leading end of the subsequent printing sheet P reaches the position of the discharge driving roller 6, the subsequent printing sheet P is intermittently transported by the PF driving roller 4, the discharge driving roller 6, and the rear feed roller 27. On the other hand, the preceding printing sheet P is intermittently transported by the discharge driving roller 6 and is discharged from the printer 1. In the intermittent transporting operation, the PF driving roller 4 and the discharge driving roller 6 are controlled in rotation on the basis of the PF speed profile F1 and the rear feed roller 27 is controlled in rotation on the basis of the feed speed profile F2. That is, the synchronous transport control operation is performed.

By means of the start correction control, the printing sheet P in transport is loosened between the PF driving roller 4 and the rear feed roller 27, and the printing sheet P in stop lose the looseness. The printing operation on the printing sheet P is performed at the time of stopping the printing sheet P.

In this way, in the continuous printing operation in the draft print mode, the PF driving roller 4 and the rear feed roller 27, which rotate at the substantially same peripheral speed, first transport the printing sheet P fed into the printer 1 (of which the leading end is transported to the position of the PF driving roller 4) in cooperation with each other. Thereafter, when the leading end of the printing sheet Preaches the position of the discharge driving roller 6, the discharge driving roller 6 transports the printing sheet P inside the printer 1 in cooperation with the PF driving roller 4 and the rear feed roller 27. Then, the trailing end of the printing sheet P departs from the rear feed roller 27, the PF driving roller 4 and the discharge driving roller 6 transport the printing sheet P inside the printer 1 in cooperation with each other.

Subsequently, a control operation at the time of transporting a final printing sheet P in the continuous printing operation will be described.

As shown in FIG. 12A, when the leading end of the final printing sheet P in the continuous printing operation is transported to the position of the PF driving roller 4 and the PF follower roller, as shown in FIGS. 3B and 12B, the lower end of the rear feed hopper 26 is separated from the rear feed roller 27 and the retard roller 28 is also separated from the rear feed roller 27. The ASF motor 31 is stopped and the rear feed roller 27 is also stopped in rotation. That is, the final printing sheet P is thereafter intermittently transported by the PF driving roller 4 or the discharge driving roller 6. In this way, the final printing sheet P is transported under the separate transport control.

Specifically, only the PF motor 14 is intermittently driven, the printing sheet P is intermittently transported by the PF driving roller 4 or the discharge driving roller 6, ink droplets are ejected from the print head 2, and thus the printing operation is performed on the printing sheet P. When the printing operation on the printing sheet P is finished, the PF motor 14 is continuously driven and the printing sheet P is discharged out of the printer 1 by the discharge driving roller 6.

In this way, by allowing the rear feed roller 27 not to be used in the transporting operation of the final printing sheet P in the continuous printing operation, it is possible to prevent the subsequent printing sheet P from being fed, even when printing sheets P of the number larger than a designated number of printing sheets are set in the rear feed hopper 26.

(Control Flow of Transport Control of Printing Sheet)

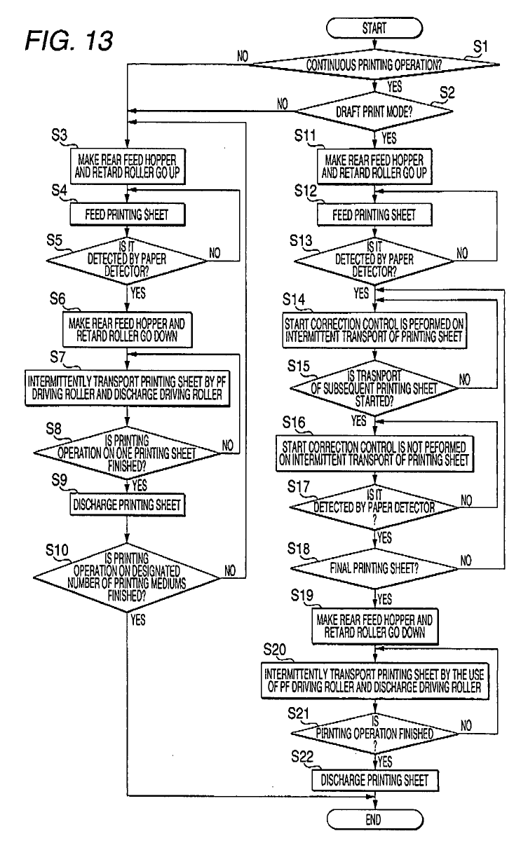

FIG. 13 is a flowchart illustrating a procedure of controlling a transport of a printing sheet P.

The procedure of controlling a transport of a printing sheet P, which has been described with reference to FIGS. 10A to 12B, will be described with reference to the flowchart shown in FIG. 13.

When a print instruction is input to the controller 50 from a control instruction unit 59, the controller 50 starts the print control operation of the printing sheet P. That is, the controller 50 starts the transport control operation of the printing sheet P. In the transport control operation, it is determined whether the printing operation on the printing sheet P is a continuous printing operation (step S1). When it is determined that the printing operation is a continuous printing operation, it is determined whether the print mode is a draft print mode (step S2).

When it is determined in step S2 that the print mode is not the draft print mode but a normal print mode, or when it is determined in step S1 that the printing operation is not the continuous printing operation but a single sheet printing operation, the separate transport control operation is performed. Specifically, first, as shown in FIG. 3A, the lower end of the rear feed hopper 26 and the retard roller 28 are made to rise (step S3) and a printing sheet P is transported and fed from the rear feed hopper 26 by the rear feed roller 27 (step S4). It is determined whether the paper detector 9 detects the leading end of the printing sheet P (step S5). When it is determined that the paper detector 9 does not detect the leading end of the printing sheet P, the process of step 54 is performed again. On the other hand, when it is determined that the paper detector 9 detects the leading end of the printing sheet P, the lower end of the rear feed hopper 26 and the retard roller 28 are made to go down, as shown in FIG. 3B (step S6).

Thereafter, the printing sheet P is intermittently transported by the PF driving roller 4 or the discharge driving roller 6 (step S7). In step S7, the rear feed roller 27 is stopped. At the time of stopping the intermittent transporting operation, a printing operation is performed on the printing sheet P by the use of the print head 2 as needed. It is determined whether the printing operation on the fed printing sheet P has been finished (step S8). When it is determined that the printing operation is not finished, the process of step S7 is performed again. On the other hand, when it is determined that the printing operation is finished, the printing sheet P is discharged by the discharge driving roller 6 (step S9). After discharging the printing sheet P or at the time of discharging the printing sheet, it is determined whether the printing operation is finished on the printing sheets of the designated number input from the control instruction unit 59 (step S10). When it is determined that the printing operation on the printing sheets of the designated number has been finished, the transport control operation of the printing sheet P is finished (that is, the control of the printing operation is finished). On the other hand, when it is determined that the printing operation on the designated number of printing sheets is not finished, the process of step S3 is performed again. When it is determined in step S1 that the printing operation is a single sheet printing operation, the process of step S10 is omitted.

When it is determined in step 52 that the print mode is the draft print mode, as shown in FIG. 3A, the lower end of the rear feed hopper 26 and the retard roller 28 is made to go up (step S11) and the printing sheet P is transported and fed from the rear feed hopper 26 by the rear feed roller 27 (step S12). In step S12, the rear feed roller 27 is controlled in rotation on the basis of the feed speed profile F2. In step S12, the PF driving roller 4 and the discharge driving roller 6 are started at the same time as starting the rear feed roller 27, and the PF driving roller 4 and the discharge driving roller 6 are controlled in rotation on the basis of the PF speed profile F1. That is, in step S12, the synchronous transport control operation is performed. In step S12, the synchronous transport control operation may not be performed.

It is determined whether the paper detector 9 detects the leading end of the printing sheet P (step S13). When it is determined that the paper detector 9 does not detect the leading end of the printing sheet P, the process of step S12 is performed again. When it is determined that the paper detector 9 detects the leading end of the printing sheet P, the printing sheet P is intermittently transported by the PF driving roller 4 and/or the discharge driving roller 6 controlled in rotation on the basis of the PF speed profile F1, and the rear feed roller 27 controlled in rotation on the basis of the feed speed profile F2 (step S14). That is, the synchronous transport control operation is performed in step S14. The start correction control operation is performed in step S14. At the time of stopping the intermittent transporting operation, the printing operation on the printing sheet P is performed by the use of the print head 2 as needed.

Thereafter, as shown in FIG. 11A, it is determined whether the trailing end of the preceding printing sheet P departs from the rear feed roller 27 and then the transport of a subsequent printing sheet P is started by the rear feed roller 27 (step S15). When it is determined that the transport of the subsequent printing sheet P is not started, the process of step S14 is performed again. When it is determined that the transport of the subsequent printing sheet P is started, the printing sheet P is intermittently transported by the PF driving roller 4 and the discharge driving roller 6 controlled in rotation on the basis of the PF speed profile F1 and the rear feed roller 27 controlled in operation on the basis of the feed speed profile F2 (step S16). That is, the synchronous transport control operation is performed in step S16. The start correction control operation is not performed in step S16. The start correction control operation may be performed in step 516.

Then, it is determined whether the paper detector 9 detects the leading end of the printing sheet P (step S17). When it is determined that the paper detector 9 does not detect the leading end of the printing sheet P, the process of step S16 is performed again. When it is determined that the paper detector 9 detects the leading end of the printing sheet P, it is determined whether the subsequent printing sheet P is a final printing sheet P in the continuous printing operation (step S18). When it is determined that the printing sheet is not the final printing sheet P, the lower end of the rear feed hopper 26 and the retard roller 28 are made to go down (step S19), similarly to step S6.

Thereafter, similarly to step S7, the printing sheet P is intermittently transported by the PF driving roller 4 and the discharge driving roller 6 (step S20). In step S20, the rear feed roller 27 is stopped. That is, the final printing sheet P is transported under the separate transport control.

At the time of stopping the intermittent transporting operation, the printing operation is performed on the printing sheet P by the use of the print head 2 as needed. Then, it is determined whether the printing operation on the final printing sheet P has been finished (step S21). When it is determined that the printing operation is not finished, the process of step S20 is performed again. When it is determined that the printing operation is not finished, the printing sheet P is discharged by the discharge driving roller 6 (step S22) and then the transport control operation on the printing sheet P is finished.

In this embodiment, step S14 and S16 constitute a step of transporting a printing sheet P in which the PF motor 4 is controlled on the basis of the PF target speed table T1 corresponding to the PF speed profile F1 and the ASF motor 31 is controlled on the basis of the ASF target speed table T2 corresponding to the feed speed profile F2.

### Advantages of Embodiment

As described above, in the continuous printing operation in the draft print mode according to this embodiment, the PF motor 14 is controlled on the basis of the PF target speed table T1 corresponding to the PF speed profile F1 and the ASF motor 31 is controlled on the basis of the ASF target speed table T2 corresponding to the feed speed profile F2. That is, the PF motor 14 is controlled on the basis of the PF speed profile F1 and the ASF motor 31 is controlled on the basis of the feed speed profile F2 substantially equal to the PF speed profile F1, whereby the PF motor 14 and the ASF motor 31 are controlled so that the speed profile of the PF driving roller 4 is substantially equal to the speed profile of the rear feed roller 27. Accordingly, the PF driving roller 4 and the rear feed roller 27 can be made to rotate in synchronization with each other. Therefore, it is possible to perform the feeding operation of a printing sheet P without hindering the discharging operation or the printing operation of the printing sheet. That is, in this embodiment, it is possible to perform the printing operation, the discharging operation, and the feeding operation as a series of operations. As a result, it is possible to enhance a throughput of the continuous printing operation in the draft print mode.

In this embodiment, since the PF driving roller 4 and the rear feed roller 27 can be made to rotate in synchronization with each other, the printing sheet P can be properly transported between the PF driving roller 4 and the rear feed roller 27. Accordingly, it is possible to suppress an occurrence of a sound in the printing sheet P, which can occur due to a variation in tension of the printing sheet P between the PF driving roller 4 and the rear feed roller 27.

In this embodiment, the PF target speed table T1 and the ASF target speed table T2 are stored in the ROM 53. Accordingly, even when the PF motor 14 and the ASF motor 31 are controlled in the synchronization control manner so as to allow the PF driving roller 4 and the rear feed roller 27 to rotate in synchronization with each other, the PF motor 14 can be controlled in the PID control manner on the basis of the PF target speed table T1 and the ASF motor 31 can be controlled in the PID control manner on the basis of the ASF target speed table T2. Accordingly, compared with the case where only the PF target speed table T1 is stored in the ROM 53 and the target rotation speed of the ASF motor 31 is calculated by the use of the above-mentioned calculation method at the time of performing the PID control operation on the basis of the first target speed table, it is possible to reduce the calculation processes in the controller 50 and thus to enhance the responsibility to the control operation.

In this embodiment, the ASF target speed table T2 is set on the basis of the ratio α of the resolution of the ASF encoder 41 to the resolution of the PF encoder 40 and the PF target speed table T1. That is, by using the PF target speed table T1 as a reference, the ASF target speed table T2 is set on the basis of the PF target speed table T1. Accordingly, the PF motor 14 driving the PF driving roller 4 closer to the print head 2 performing the printing operation is used as a reference for the synchronous control operation. As a result, it is possible to enhance the stop precision of the printing sheet P relative to the print head 2 and thus to enhance the print precision. Specifically, in this embodiment, since the PF encoder 40 is attached to the PF driving roller 4, it is possible to further enhance the stop precision of the printing sheet P by using the PF motor 14 as a reference. In this embodiment, the ASF encoder 41 is attached to the output shaft of the ASF motor 31. Accordingly, it is possible to control the positions and the speeds of both rollers of the rear feed roller 27 and the front feed roller 21 by the use of the ASF encoder 41. Therefore, it is possible to simplify the configuration of the printer 1.

### Other Embodiments

The above-mentioned embodiment is an exemplary embodiment of the invention, but the invention is not limited to the embodiment. The invention can be modified in various forms without departing from the gist of the invention.

In the above-mentioned embodiment, the PF target speed table T1 and the ASF target speed table T2 are stored in the ROM 53. Otherwise, only the PF target speed table T1 may be stored in the ROM 53 and the target rotation speed of the ASF motor 31 corresponding to the pulses of the ASF pulse signal may be calculated by the above-mentioned calculation method at the time of performing the PID control operation on the basis of the PF target speed table T1. In this case, compared with the case where the PF target speed table T1 and the ASF target speed table T2 are stored in the ROM 53, it is possible to reduce the storage capacity of the ROM 53.

In the above-mentioned embodiment, the PF target speed table T1 and the ASF target speed table T2 are set so that the PF speed profile F1 prepared on the basis of the PF target speed table T1 is equal to the feed speed profile F2 prepared on the basis of the ASF target speed table T2, and the start correction control operation is performed when a printing sheet P is transported by both rollers of the PF driving roller 4 and the rear feed roller 27 in the drafter print mode. Accordingly, the printing sheet P between the PF driving roller 4 and the rear feed roller 27 is loosened at the time of transport but lose the looseness at the time of stop. Otherwise, for example, when the start correction control operation is performed by slightly correcting the ASF target speed table T2, the printing sheet P transported by the PF driving roller 4 and the rear feed roller 27 may be always loosened between the PF driving roller 4 and the rear feed roller 27.

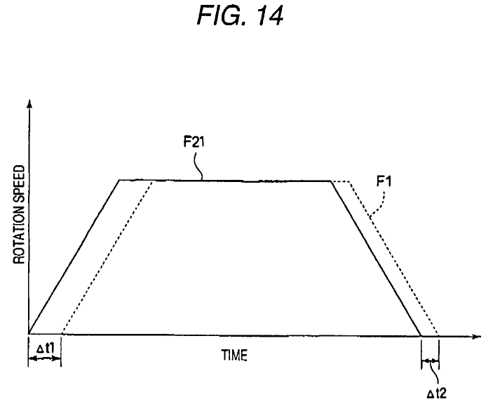

For example, as shown in FIG. 14, the ASF target speed table T2 may be set with reference to the PF target speed table T1 so that the uniform-speed region of the feed speed profile F2 is slightly longer than that of the PF speed profile F1. That is, at the time of performing the start correction control operation, the ASF target speed table T2 may be set with reference to the PF target speed table T1 so that the PF motor 14 is started later by Δt1 than the ASF motor 31 and is stopped later by Δt2 (Δt1>Δt2) than the ASF motor 31, that is, so that the rear feed roller 27 transports the printing sheet P more than the PF driving roller 4. When the start correction control operation is performed in this way, the printing sheet P transported by the PF driving roller 4 and the rear feed roller 27 may be always loosened between the PF driving roller 4 and the rear feed roller 27, whereby it is possible to suppress the occurrence of a sound in the printing sheet P which may occur at the time of transporting the printing sheet.

In addition, in the above-mentioned embodiment, the method of controlling the transport of a printing sheet P in the printer 1 is described with reference to the case where the printing sheet P is fed into the printer 1 from the rear side. That is, in the above-mentioned embodiment, in the continuous printing operation in the draft print mode, the PF motor 14 is controlled on the basis of the PF target speed table T1 corresponding to the PF speed profile F1 and the ASF motor 31 is controlled on the basis of the ASF target speed table T2 corresponding to the feed speed profile F2. Otherwise, for example, the PF motor 14 may be controlled on the basis of the PF target speed table T1 corresponding to the PF speed profile F1 and the ASF motor 31 may be controlled on the basis of the ASF target speed table corresponding to the speed profile substantially equal to the PF speed profile F1 and indicating a relationship between the rotation time or the rotation distance and the target rotation speed of the front feed roller 21. That is, the transport control on the printing sheet P according to this embodiment can be applied to a case where a printing sheet P is fed into the printer 1 from the front side. In this case, it is preferable that a detector having the same function as the paper detector 9 is disposed at a position close to the front feed roller 21. In this case, the front feed roller 21 serves as a feed roller for feeding a printing sheet P into the printer 1 and the front feed cassette 20 serves as a medium setting portion in which non-printed printing sheets are set.

In the above-mentioned embodiment, in the continuous printing operation in the draft print mode, when the leading end of the first printing sheet P is transported and fed to the position of the PF driving roller 4 and the PF follower roller 5, the synchronization transport control is performed. Otherwise, for example, when the leading end of the first printing sheet P is transported to the position of the PF driving roller 4 and the PF follower roller 5, only the ASF motor 31 may be driven to rotate only the rear feed roller 27, similar to the related case.

In the above-mentioned embodiment, the PF motor 14 and the ASF motor 31 are controlled in the PID control manner. Otherwise, the PF motor 14 and the ASF motor 31 may be controlled in a feedback control manner such as PI control or proportional control. The configuration of this embodiment can be applied to a variety of apparatuses having a feed mechanism, such as a laser printer, in addition to the ink jet printers.

What is claimed is:

1. A printer for performing a printing operation on a printing medium, the printer comprising:
a feed roller, operable to feed the printing medium from a medium setting portion in which the printing medium is set;
a feeding motor, operable to drive the feed roller;
a transport roller, operable to transport the printing medium fed from the medium setting portion;
a transporting motor, operable to drive the transport roller; and
a controller, operable to control the transporting motor based on a first speed profile indicating a relationship between a rotation time or a rotation distance and a target peripheral speed of the transport roller, and to control the feeding motor based on a second speed profile indicating a relationship between a rotation time or a rotation distance and a target peripheral speed of the feed roller and being substantially equal to the first speed profile.

2. The printer according to claim 1, wherein
the controller stores a first target speed table which corresponds to the first speed profile and in which a target rotation speed corresponding to a rotation time or a rotation distance of the transporting motor is set and a second target speed table which corresponds to the second speed profile and in which a target rotation speed corresponding to a rotation time or a rotation distance of the feeding motor is set.

3. The printer according to claim 2, further comprising:
a first encoder for detecting the rotation distance and the rotation speed of the transporting motor; and
a second encoder for detecting the rotation distance and the rotation speed of the feeding motor,
wherein the second target speed table is set based on the first target speed table and a ratio of a resolution of the first encoder and a resolution of the second encoder.

4. The printer according to claim 3, wherein
the first encoder includes a first scale attached to the transport roller, and
the second encoder includes a second scale attached to the feeding motor.

5. The printer according to claim 1, wherein
the controller stores a first target speed table in which a target rotation speed corresponding to a rotation time or a rotation distance of the transporting motor, and
the controller calculates a target rotation speed corresponding to a rotation time or a rotation distance of the feeding motor based on the first target speed table so as to prepare the second speed profile substantially equal to the first speed profile prepared based on the first target speed table.

6. A method of controlling a printer for performing a printing operation on a printing medium, the method comprising:
controlling a transporting roller that drives a transport roller for transporting a printing medium fed from a medium setting portion in which the printing medium is set, based on a first speed profile indicating a relationship between a rotation time or a rotation distance and a target peripheral speed of the transport roller; and
controlling a feeding motor that drives a feed roller for feeding the printing medium from the medium setting portion, based on a second speed profile indicating a relationship between a rotation time or a rotation distance and a target peripheral speed of the feed roller and being substantially equal to the first speed profile.

7. A printer comprising:
a first roller, operable to transport a medium in a first direction;
a first motor, operable to drive the first roller;
a second roller, operable to transport the medium and disposed at a downstream side of the first roller in the direction;
a second motor, operable to drive the second roller; and
a controller, operable to
control the second motor based on a first speed profile indicating a relationship between one of a rotation time and a rotation distance of the second roller and
a target peripheral speed of the second roller, and control the first motor based on a second speed profile indicating a relationship between one of a rotation time and a rotation distance of the first roller and a target peripheral speed of the first roller and being substantially equal to the first speed profile.
